(19) United States
(12) Patent Application Publication
(10) Pub. No.: US 2021/0319457 A1
(43) Pub. Date: Oct. 14, 2021

(54) UTILIZING MODELS TO AGGREGATE DATA AND TO IDENTIFY INSIGHTS FROM THE AGGREGATED DATA

(71) Applicant: Capital One Services, LLC, McLean, VA (US)

(72) Inventors: John CURRIER, Plano, TX (US); Dustin DOUGLAS, Plano, TX (US)

(21) Appl. No.: 16/843,552

(22) Filed: Apr. 8, 2020

(51) Int. Cl. G06Q 30/02; G06F 16/242; G06Q 30/00; G06N 20/00

(52) U.S. Cl. CPC G06Q 30/0201; G06N 20/00; G06Q 30/01; G06F 16/244

(57) ABSTRACT

A device receives first historical customer data associated with customers that interact with merchants, and receives second historical customer data associated with the customers. The device trains a first model with the first historical customer data and the second historical customer data to generate a trained first model that outputs customer sentiment data, and trains a second model with the customer sentiment data to generate a trained second model that outputs customer insight data. The device receives first customer data associated with a customer interacting with a merchant, and receives second customer data associated with the customer. The device processes the first customer data and the second customer data, with the trained first model, to determine the customer sentiment, and processes the customer sentiment data, with the trained second model, to determine the customer insight data. The device performs one or more actions based on the customer insight data.

### BACKGROUND

Customers interact with merchants via a variety of communication mechanisms. For example, customers may interact with merchants in face-to-face conversations, via customer service calls, via chat sessions online, via online feedback mechanisms, and/or the like.

### SUMMARY

According to some implementations, a method may include receiving first historical customer data associated with customers that interact with merchants, and receiving second historical customer data associated with the customers, wherein the second historical customer data includes data unassociated with interactions with the merchants. The method may include processing the first historical customer data and the second historical customer data to generate first structured historical customer data and second structured historical customer data, and training a first model with the first structured historical customer data and the second structured historical customer data to generate a trained first model, wherein the trained first model is configured to output customer sentiment data. The method may include training a second model with the customer sentiment data to generate a trained second model, wherein the trained second model is configured to output customer insight data, and receiving first customer data associated with a customer interacting with a merchant. The method may include receiving second customer data associated with the customer, wherein the second customer data includes data unassociated with interactions between the customer and the merchant, and processing the first customer data and the second customer data, with the trained first model, to determine a sentiment of the customer. The method may include processing data identifying the sentiment of the customer, with the trained second model, to determine the customer insight data that indicates an insight of the customer, and performing one or more actions based on the customer insight data.

According to some implementations, a device may include one or more memories, and one or more processors to receive first customer data associated with a customer interacting with a merchant, and receive second customer data associated with the customer, wherein the second customer data includes data unassociated with interactions between the customer and the merchant. The one or more processors may process the first customer data and the second customer data to generate first structured customer data and second historical customer data, and may process the first structured customer data and the second structured customer data, with a first model, to determine a sentiment of the customer. The first model may have been trained based on first historical customer data associated with customers that interact with merchants, and second historical customer data that includes data unassociated with interactions between the customers and the merchants. The first model may be configured to output customer sentiment data. The one or more processors may process data identifying the sentiment of the customer, with a second model, to determine an insight of the customer. The second model may have been trained based on the customer sentiment data, and may be configured to output customer insight data. The one or more processors may perform one or more actions based on determining the insight of the customer.

According to some implementations, a non-transitory computer-readable medium may store one or more instructions that, when executed by one or more processors of a device, may cause the one or more processors to receive first historical customer data associated with customers that interact with merchants, and receive second historical customer data associated with the customers, wherein the second historical customer data includes data unassociated with interactions with the merchants. The one or more instructions may cause the one or more processors to process the first historical customer data and the second historical customer data to convert the first historical customer data and the second historical customer data from an unstructured format into a particular structured format, and aggregate the first historical customer data and the second historical customer data, in the particular structured format, to generate aggregated data. The one or more instructions may cause the one or more processors to train a first model with the aggregated data to generate a trained first model that is configured to output customer sentiment data, and train a second model with the customer sentiment data to generate a trained second model that is configured to output customer insight data. The one or more instructions may cause the one or more processors to receive first customer data associated with a customer interacting with a merchant, and receive second customer data associated with the customer, wherein the second customer data includes data unassociated with interactions between the customer and the merchant. The one or more instructions may cause the one or more processors to process the first customer data and the second customer data, with the trained first model, to determine a sentiment of the customer as the customer sentiment data, and process data identifying the sentiment of the customer, with the trained second model, to determine an insight of the customer as the customer insight data. The one or more instructions may cause the one or more processors to perform one or more actions based on the insight of the customer.

### BRIEF DESCRIPTION OF THE DRAWINGS

FIGS. 1A-1I are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for utilizing models to aggregate data and to identify insights from the aggregated data.

### DETAILED DESCRIPTION

The following detailed description of example implementations refers to the accompanying drawings. The same reference numbers in different drawings may identify the same or similar elements.

A merchant or an employee of a merchant may wish to have insights about a customer in order to better serve the customer, provide offers for goods and/or services that may be appropriate for the customer, and/or the like. However, since information about the customer may come from a variety of communication mechanisms (e.g., in unstructured and/or different formats), determining insights about the customer based on such information is extremely difficult. Thus, merchants waste computing resources (e.g., processing resources, memory resources, and/or the like), networking resources, and/or the like associated with attempting to analyze unstructured and incomplete information about customers, incorrectly inferring insights about customers based on the incomplete information, improperly serving the customers based on the incorrect insights, and/or the like.

Some implementations described herein provide a data aggregation platform that utilizes models to aggregate data and to identify insights from the aggregated data. For example, the data aggregation platform may receive first historical customer data associated with customers that interact with merchants, and may receive second historical customer data associated with the customers, where the second historical customer data may include data unassociated with interactions with the merchants. The data aggregation platform may train a first model with the first historical customer data and the second historical customer data to generate a trained first model, where the trained first model may be configured to output customer sentiment data. The data aggregation platform may train a second model with the customer sentiment data to generate a trained second model, where the trained second model may be configured to output customer insight data. The data aggregation platform may receive first customer data associated with a customer interacting with a merchant, and may receive second customer data associated with the customer, where the second customer data may include data unassociated with interactions between the customer and the merchant. The data aggregation platform may process the first customer data and the second customer data, with the trained first model, to determine a sentiment of the customer, and may process data identifying the sentiment of the customer, with the trained second model, to determine the customer insight data that indicates an insight of the customer. The data aggregation platform may perform one or more actions based on the customer insight data.

In this way, the data aggregation platform enables a merchant to aggregate data associated with customers and identify insights about the customers from the aggregated data. This prevents waste of computing resources (e.g., processing resources, memory resources, and/or the like), networking resources, and/or the like associated with attempting to analyze unstructured and incomplete information about customers, incorrectly inferring insights about customers based on the incomplete information, improperly serving the customers based on the incorrect insights, and/or the like.

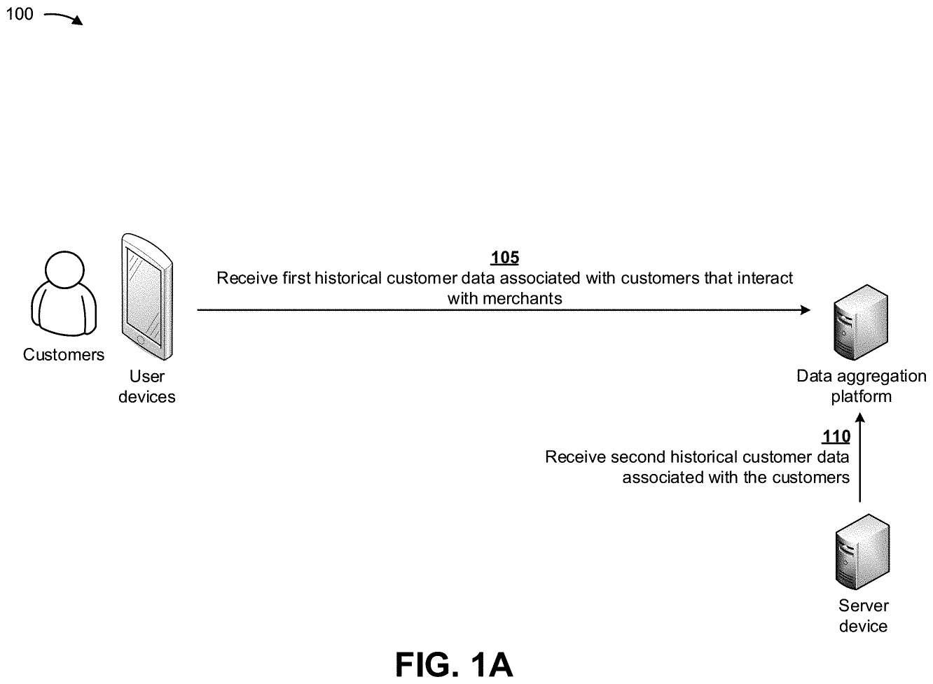

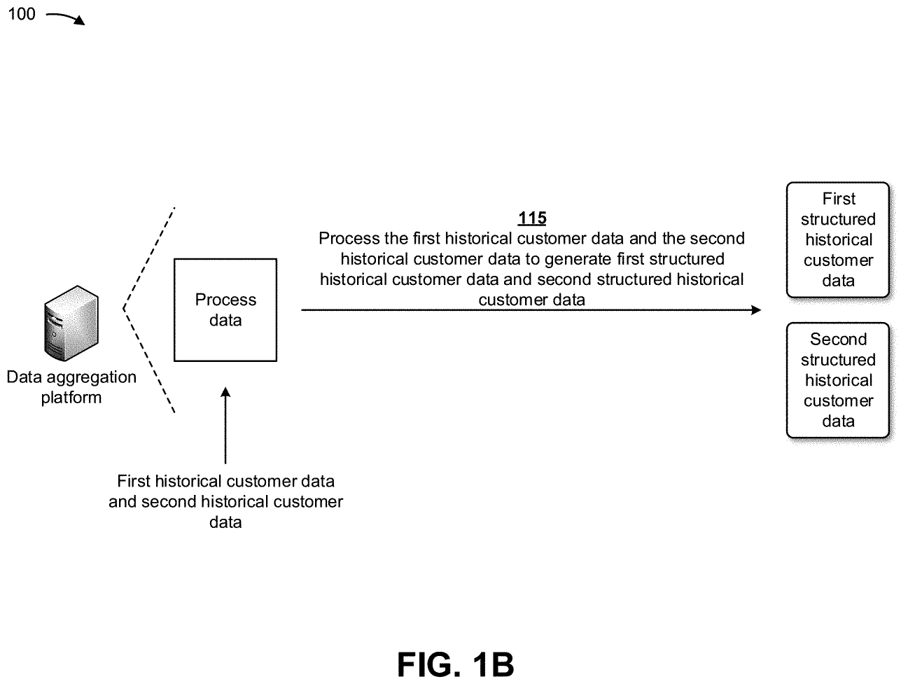

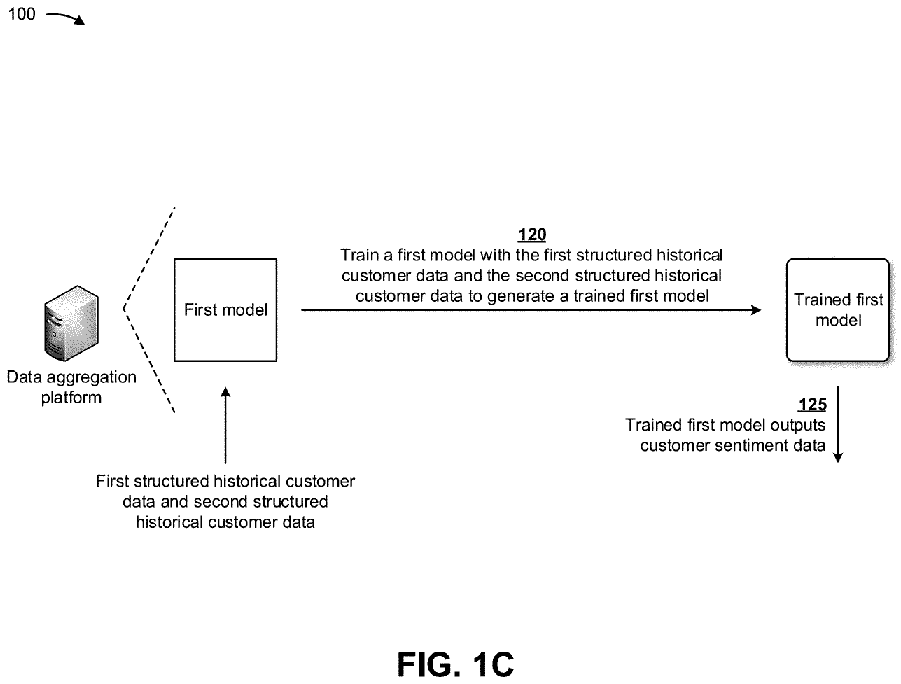

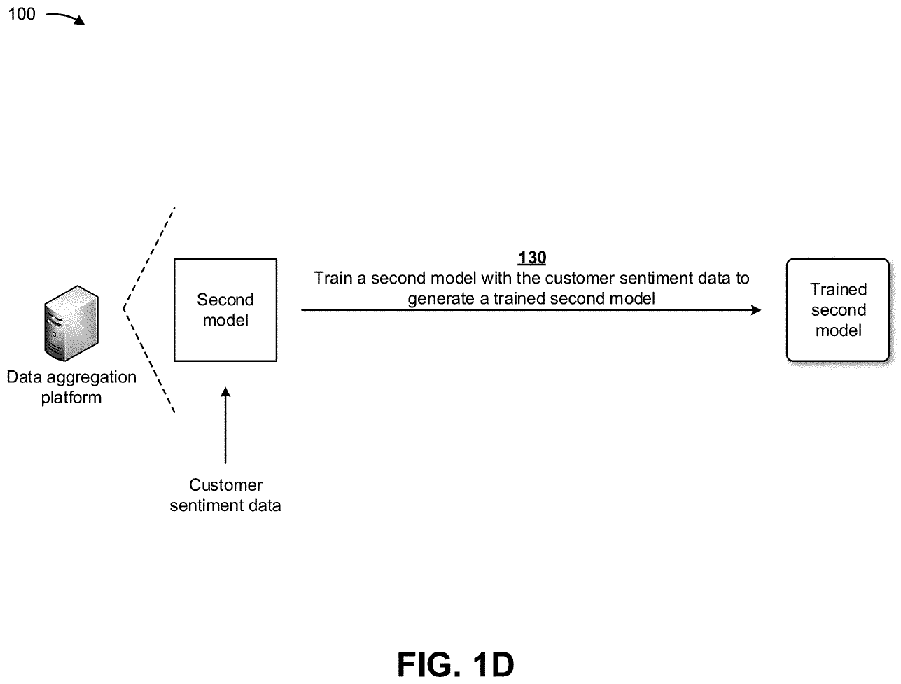

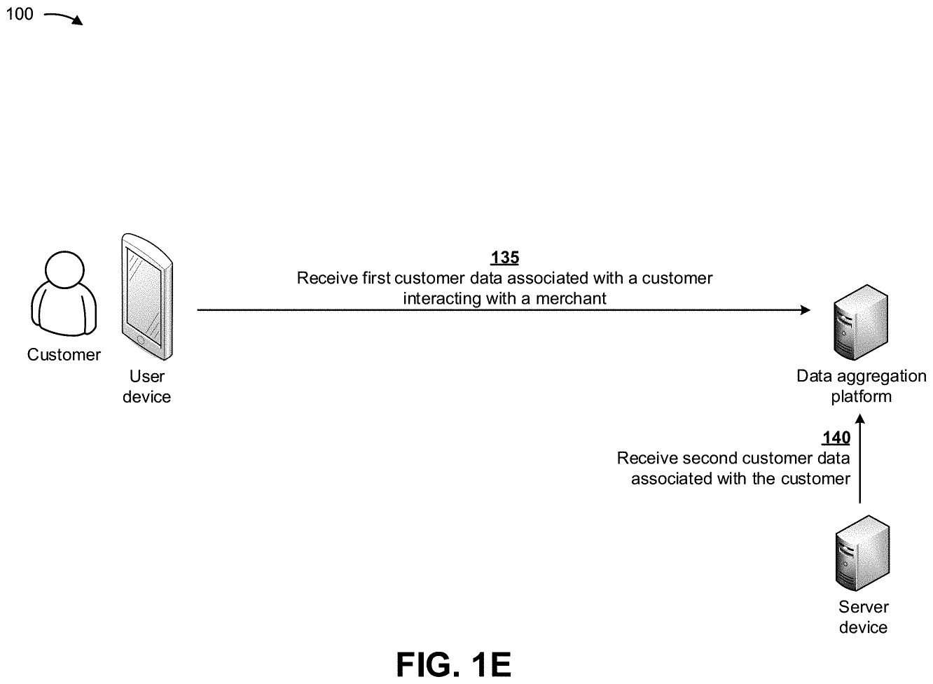

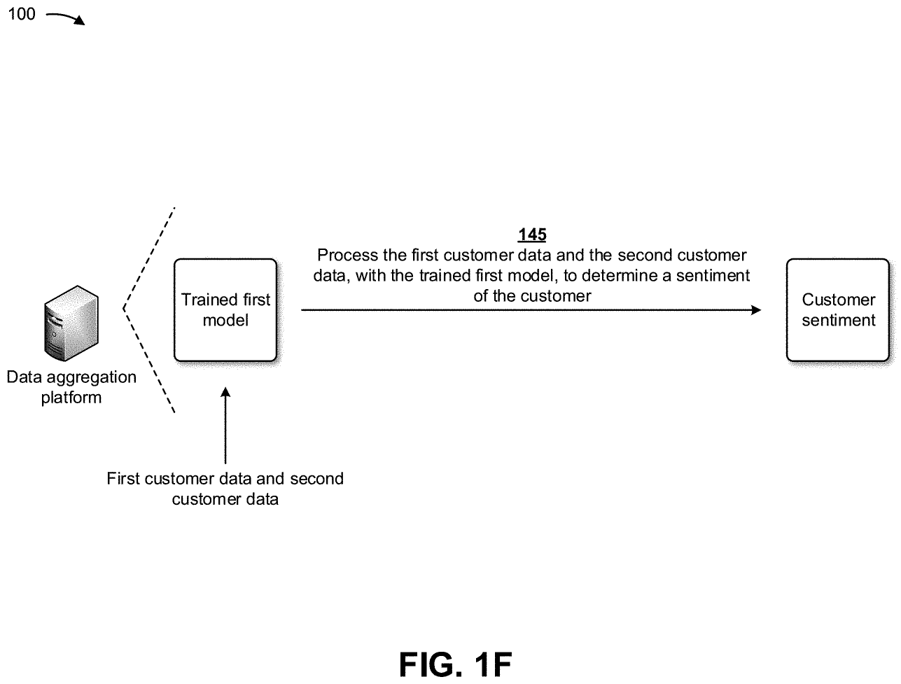

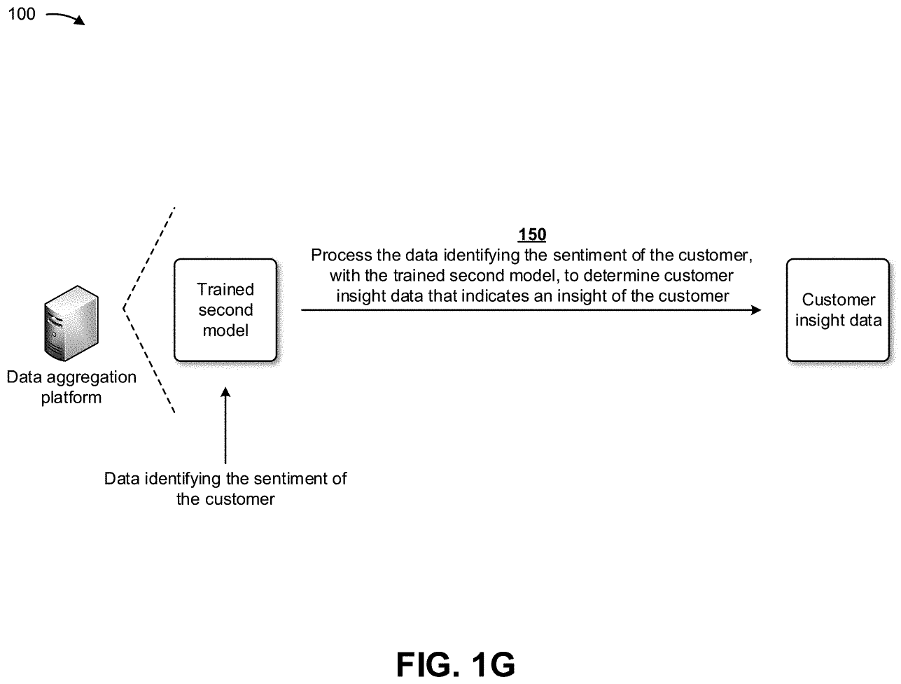

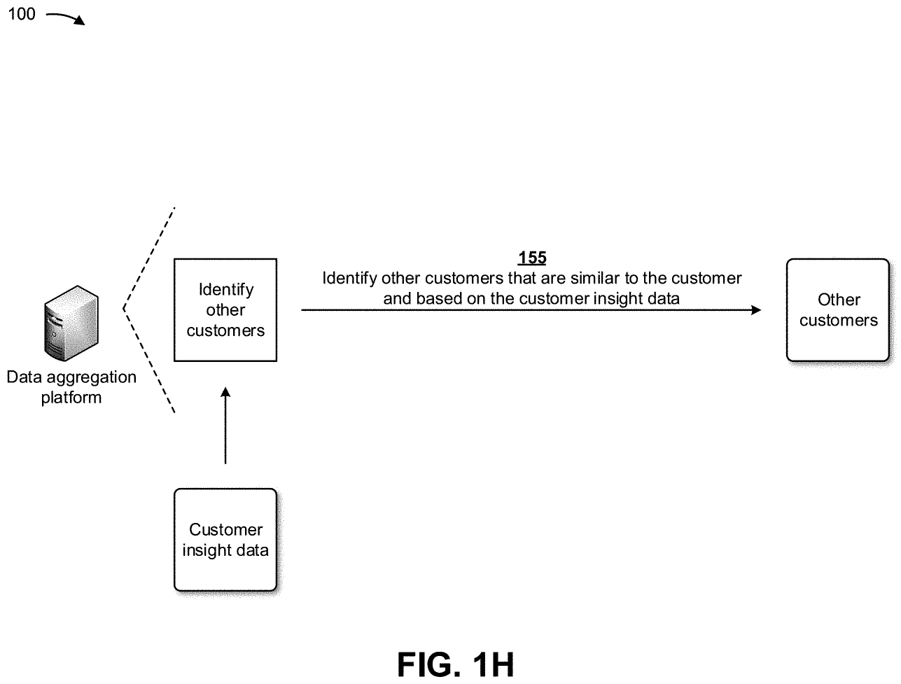

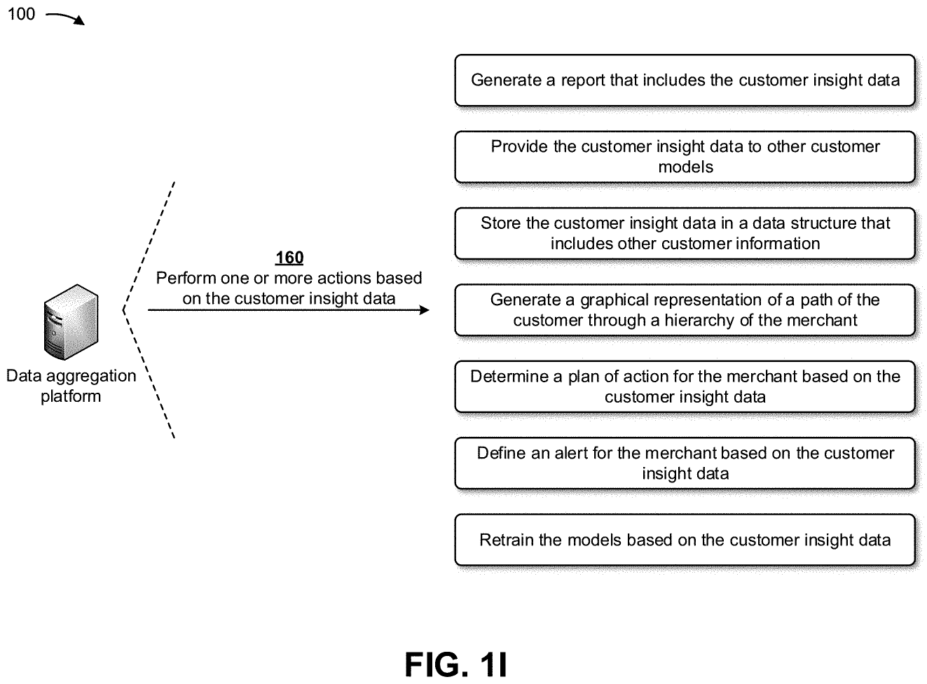

FIGS. 1A-1H are diagrams of one or more example implementations 100 described herein. As shown in FIG. 1A, user devices and a server device may be associated with a data aggregation platform. As further shown, the user devices may be associated with customers that interact with merchants (e.g., that provide goods and/or services to the customers). The server device may be associated with merchants, financial institutions (e.g., banks), and/or the like, that may receive and/or store information associated with the customers.

As further shown in FIG. 1A, and by reference number 105, the data aggregation platform may receive, from the user devices, first historical customer data associated with customers that interact with merchants. In some implementations, the data aggregation platform may periodically receive the first historical customer data, may continuously receive the first historical customer data, may receive the first historical customer data based on a request, and/or the like. The data aggregation platform may store the first historical customer data in a data structure (e.g., a database, a list, a table, and/or the like) associated with the data aggregation platform.

In some implementations, the first historical customer data may include data generated based on customer interactions with merchants (e.g., entities that sell, lease, purchase, and/or the like goods and/or services to and/or from customers). The customers may interact with the merchants in a variety of ways, and the first historical customer data may be captured in a variety of different formats. For example, the first historical customer data may include data identifying notes about the customers that are generated by employees of the merchants, data identifying transcripts of customer service calls between the merchants and the customers, data identifying transcripts of online customer chats between the merchants and the customers, data identifying text messages exchanged between the merchants and the customers, data identifying emails exchanged between the merchants and the customers, data identifying transcripts of bot chats with the customers, purchase history data (e.g., data identifying dates of purchases, items purchased, cost of purchases, methods of payment for purchases, returns of items purchased, and/or the like) associated with the customers, and/or the like.

As further shown in FIG. 1A, and by reference number 110, the data aggregation platform may receive, from the server device, second historical customer data associated with the customers. In some implementations, the data aggregation platform may periodically receive the second historical customer data, may continuously receive the second historical customer data, may receive the second historical customer data based on a request, and/or the like. The data aggregation platform may store the second historical customer data in a data structure associated with the data aggregation platform.

In some implementations, the second historical customer data may include data unassociated with interactions with the merchants. For example, the second historical customer data may include data that is not based on customer interactions with the merchants, but may be based on data received from other sources associated with the customers. The second historical customer data may include financial data (e.g., data associated with bank accounts, credit card accounts, debit card accounts, and/or the like) associated with the customers, demographic data (e.g., data identifying marital status, number of children, occupation, income, education, and/or the like) associated with the customers, data captured by cameras in merchant stores with respect to particular products offered by the merchants, and/or the like.

In some implementations, there may be hundreds, thousands, millions, and/or the like, of user devices and/or server devices that produce thousands, millions, billions, and/or the like, of data points provided in the first historical customer data and/or the second historical customer data. In this way, the data aggregation platform may handle thousands, millions, billions, and/or the like, of data points within a period of time (e.g., daily, weekly, monthly), and thus may provide “big data” capability.

As shown in FIG. 1B, and by reference number 115, the data aggregation platform may process the first historical customer data and the second historical customer data to generate first structured historical customer data and second structured historical customer data. For example, the first historical customer data and the second historical customer data may be received from a variety of sources and in a variety of formats, and the data aggregation platform may convert the variety of formats to a common structured format that may be utilized by machine learning models, as described herein.

The data aggregation platform may process and/or aggregate the first historical customer data and/or the second historical customer data. For example, the data aggregation platform may process the first historical customer data and the second historical customer data to convert the first historical customer data and the second historical customer data from an unstructured format into a particular structured format, and may aggregate the first historical customer data and the second historical customer data, in the particular structured format, to generate aggregated data (e.g., in a structured format that can be interpreted and processed by the first model). In this case, the data aggregation platform may train the first model with the aggregated data.

For example, the data aggregation platform may perform natural language processing (e. g., syntax, semantics, discourse, speech, and/or the like) on the first historical customer data and the second historical customer data so that the first historical customer data and the second historical customer data may be readily interpreted by machine learning models of the data aggregation platform. The data aggregation platform may preprocess the first historical customer data and the second historical customer data by converting formats of the first historical customer data and the second historical customer data into at least one predetermined format that may be interpreted by the natural language processing and/or the data aggregation platform.

The natural language processing may extract an intent of text (e. g., a question) of the first historical customer data and the second historical customer data. An intent may include an intention of a customer that is conveyed by the customer, such as, for example, a casual intent, a business intent, and/or the like. A casual intent may include an opening or a closing of a conversation (e.g., greetings such as “hi,” “hello,” “hola,” “ciao,” “bye,” and/or the like). A casual intent may also include affirmative and negative intents for utterances (e.g., “ok,” “yes please,” “no not this one but the first one,” “nope,” and/or the like). A business intent may include an intent that directly maps to a business associated with customers. For example, if the entity is associated with movie content, then an utterance from a user (e.g., “when was this movie released?”) may be a business intent that intends to determine a release year of the movie.

The data aggregation platform may pre-process the first historical customer data and the second historical customer data before performing the natural language processing on the first historical customer data and the second historical customer data, before storing the first historical customer data and the second historical customer data in the data structure, and/or the like. For example, the data aggregation platform may utilize one or more pre-processing techniques to pre-process the first historical customer data and the second historical customer data, such as data cleansing techniques, data reduction techniques, data transformation techniques, and/or the like. The data aggregation platform may select the one or more pre-processing techniques based on a variety of factors, such as a type associated with the first historical customer data and the second historical customer data (e.g., video data, image data, text data, and/or the like), whether a source of the first historical customer data and the second historical customer data provides voluminous data that needs to be cleaned and/or reduced in size, whether the first historical customer data and the second historical customer data is provided in a format that requires conversion to a particular format that may be utilized by the data aggregation platform, and/or the like.

The data cleansing techniques may include techniques that detect and correct (or remove) corrupt or inaccurate records from the first historical customer data and the second historical customer data, and that identify incomplete, incorrect, inaccurate, or irrelevant portions of the first historical customer data and the second historical customer data and replace, modify, delete the identified portions of the first historical customer data and the second historical customer data.

The data reduction techniques may include techniques that transform numerical or alphabetical digital information (e.g., the first historical customer data and the second historical customer data) into a corrected, ordered, and simplified form, and that reduce a quantity of the first historical customer data and the second historical customer data to meaningful parts.

The data transformation techniques may include techniques that convert the first historical customer data and the second historical customer data from one format or structure into another format or structure. The data transformation may be simple or complex based on required changes to the first historical customer data and the second historical customer data between source (initial) data and target (final) data.

The data aggregation platform may aggregate the first historical customer data and/or the second historical customer data, after processing, utilizing a data aggregation technique. The data aggregation technique may include a process in which information is gathered and expressed in a summary form, for purposes such as statistical analysis. For example, the data aggregation platform may aggregate the first historical customer data and/or the second historical customer data to obtain more information about particular groups (e.g., customers) based on specific variables such as profession, income, and/or the like. The data aggregation technique may include online analytic processing (OLAP) technique.

The data aggregation platform may further pre-process the first historical customer data and the second historical customer data by cleaning the first historical customer data and the second historical customer data based on inconsistent values, duplicate records, invalid entries, and/or the like, by merging duplicate records based on industry-specific domain knowledge, and by transforming and scaling the first historical customer data and the second historical customer data using data manipulation and feature detection.

As shown in FIG. 1C, and by reference number 120, the data aggregation platform may train a first model with the first structured historical customer data and the structured second historical customer data to generate a trained first model. The first model may include a machine learning model, such as a latent Dirichlet allocation (LDA) model, a sentiment analysis model, and/or the like. An LDA model is a type of topic model, such as a model that can be used to identify abstract topics that occur in a collection of documents, a generative statistical model that allows sets of observations to be explained by unobserved groups that explain why some parts of the data are similar, and/or the like. For example, if observations are words provided in documents, the LDA model may determine that each document is associated with a mixture of a quantity of topics and that the presence of each word is attributable to one topic, of the quantity of topics. In some implementations, a different first model may be associated with each of the merchants, the first model may be associated with all of the merchants, and/or the like.

A sentiment analysis model may identify and extract subjective information from the first structured historical customer data and the second structured historical customer data to determine customer sentiments about subjects discussed by the customers. For example, the sentiment analysis model may obtain strings of text in the first structured historical customer data and/or the second structured historical customer data, and may predict, based on the text, customer sentiment (e.g., angry, happy, satisfied, unsatisfied, and/or the like). In some implementations, the sentiment analysis model may determine one or more sentiment scores (e.g., where the scores provide indications of types of customer sentiments) based on the first structured historical customer data and/or the second structured historical customer data.

The data aggregation platform may separate the first structured historical customer data and/or the second structured historical customer data into a training set, a validation set, a test set, and/or the like. The training set may be utilized to train the first model. The validation set may be utilized to validate results of the trained first model. The test set may be utilized to test operation of the trained first model.

The data aggregation platform may train the first model using, for example, an unsupervised training procedure and based on the first structured historical customer data and/or the second structured historical customer data. For example, the data aggregation platform may perform dimensionality reduction to reduce the first structured historical customer data and/or the second structured historical customer data to a minimum feature set, thereby reducing resources (e.g., processing resources, memory resources, and/or the like) to train the first model, and may apply a classification technique to the minimum feature set.

The data aggregation platform may use a logistic regression classification technique, a non-linear tree-based classification technique (e.g., a random forest technique), and/or the like to determine a categorical outcome (e.g., customer sentiments identified by the first structured historical customer data and/or the second structured historical customer data). Additionally, or alternatively, the data aggregation platform may use a naïve Bayesian classifier technique. In this case, the data aggregation platform may perform binary recursive partitioning to split the first structured historical customer data and/or the second structured historical customer data into partitions and/or branches and use the partitions and/or branches to determine outcomes (e.g., customer sentiments identified by the first structured historical customer data and/or the second structured historical customer data). Based on using recursive partitioning, the data aggregation platform may reduce utilization of computing resources relative to manual, linear sorting and analysis of data points, thereby enabling use of thousands, millions, or billions of data points to train the first model, which may result in more accurate models than using fewer data points.

Additionally, or alternatively, the data aggregation platform may use a support vector machine (SVM) classifier technique to generate a non-linear boundary between data points in the training set. In this case, the non-linear boundary is used to classify test data into a particular class.

Additionally, or alternatively, the data aggregation platform may train the first model using a supervised training procedure that includes receiving input to the first model from a subject matter expert, which may reduce an amount of time, an amount of processing resources, and/or the like to train the first model relative to an unsupervised training procedure. In some implementations, the data aggregation platform may use one or more other model training techniques, such as a neural network technique, a latent semantic indexing technique, and/or the like. For example, the data aggregation platform may perform an artificial neural network processing technique (e.g., using a two-layer feedforward neural network architecture, a three-layer feedforward neural network architecture, and/or the like) to perform pattern recognition with regard to patterns of the first structured historical customer data and/or the second structured historical customer data. In this case, using the artificial neural network processing technique may improve an accuracy of the trained first model generated by the data aggregation platform by being more robust to noisy, imprecise, or incomplete data, and by enabling the data aggregation platform to detect patterns and/or trends undetectable to human analysts or systems using less complex techniques.

In some implementations, rather than training the first model, the data aggregation platform may receive the first model from another device (e.g., a server device). For example, a server device may generate the first model based on having trained the first model in a manner similar to that described above and may provide the first model to the data aggregation platform (e.g., may pre-load the data aggregation platform with the first model, may receive a request from the data aggregation platform for the first model, and/or the like).

As further shown in FIG. 1C, and by reference number 125, the trained first model may output customer sentiment data. For example, the customer sentiment data may include data associated with polarities of customer opinions (e.g., very positive, positive, neutral, negative, very negative), data associated with customer emotions (e.g., moods, feelings, angry, happy, satisfied, unsatisfied, and/or the like), data identifying customer intentions (e.g. interested in a product and/or a service, not interested in a product and/or a service, and/or the like), data identifying aspects of products and/or services to which customer opinions apply, data identifying classifications of customer sentiment (e.g., positive, neutral, negative, and/or the like), data identifying an extent of customer sentiment (e.g., a numerical score indicating a degree of satisfaction, and/or the like). In some implementations, a sentiment of a customer may include a sentiment relate to a merchant, a product of the merchant, a service of the merchant, advertising of the merchant, and/or the like.

In one example, the trained first model may determine the customer sentiment data based on any interactions that a customer had with a merchant (e.g., including interactions on social media), data indicating that the customer purchased a particular item from the merchant, a call log indicating that the merchant and the customer discuss the particular item, and/or the like. The trained first model may determine, from the call log, whether the customer is happy or unhappy with the particular item.

As shown in FIG. 1D, and by reference number 130, the data aggregation platform may train a second model with the customer sentiment data to generate a trained second model. In some implementations, the second model may be trained in a manner similar to that described above in connection with FIG. 1C. The trained second model may be configured to output customer insight data (e.g., data identifying insights of the customers). Customer insights may include an interpretation of trends in human behaviors that can be used to increase effectiveness of a product and/or a service for customers, to increase sales for merchants, and/or the like. Customer insights may provide indications of why customers care for a brand; may provide indications of the underlying mindsets, moods, motivation, desires, aspirations, and/or the like of customers that motivate and trigger customer attitudes and actions; and/or the like. For example, customer insights may be associated with non-obvious understandings of customers that, if acted upon, have the potential to change behaviors of the customers for the benefit of the merchants and the customers.

In some implementations, the second model may include an impact assessment model, a customers as assets model, a propensity model, a cross-sell analysis model, a critical lag model, and/or the like. The impact assessment model may perform an impact assessment to enable a merchant to understand how actions taken by the merchant, or a business entity associated with the merchant, affect behaviors of customers of the merchant. The impact assessment model may provide predicted reactions of customers to changes (e.g., proposed by the impact assessment model) that may potentially be made by the merchant.

The customers as assets model may perform a customers as assets analysis that measures a lifetime value of a customer base of a merchant (e.g., a group of customers who repeatedly purchase goods and/or services of a merchant), and enables the merchant to measure factors such as costs of acquisition (e.g., costs of acquiring customers, related assets, and/or the like) and rates of churn of business associated with the merchant.

The propensity model may predict future behaviors of customers based on previous actions and enable merchants to understand how likely it is that customers will behave in predetermined ways. The propensity model may provide a statistical scorecard that can be used by a merchant to predict behaviors of customers or prospective customers of the merchant. For example, the propensity model may be used to identify customers most likely to respond to an offer or an advertisement.

The cross-sell analysis model may identify product and/or service relationships to enable a merchant to better understand which combinations of products and/or services are likely to be most popular with customers. The merchant may then use identified relationships to cross-sell (e.g., sell multiple products offered by the merchant to a new or existing customer) and/or up-sell (e.g., sell higher value products/services to an existing customer) in the future.

The critical lag model may determine purchase patterns of a customer to enable merchants to deliver specific customer communications to the customer based on the purchase patterns of the customer. This may enable merchants to increase customer loyalty and improve customer retention.

In some implementations, rather than training the second model, the data aggregation platform may receive the second model from another device (e.g., a server device). For example, a server device may generate the second model based on having trained the second model in a manner similar to that described above and may provide the second model to the data aggregation platform (e.g., may pre-load the data aggregation platform with the second model, may receive a request from the data aggregation platform for the second model, and/or the like).

As shown in FIG. 1E, and by reference number 135, the data aggregation platform may receive, from a user device, first customer data associated with a customer interacting with a merchant. In some implementations, the first customer data may include data based on an interaction of the customer with the merchant over a period of time. For example, the first customer data may include data identifying notes about the customer that are generated by employees of the merchant over a period of time, data identifying transcripts of customer service calls between the merchant and the customer over a period of time, data identifying transcripts of online customer chats between the merchant and the customer over a period of time, data identifying text messages exchanged between the merchant and the customer over a period of time, data identifying emails exchanged between the merchant and the customer, purchase history data associated with the customer over a period of time, and/or the like. In some implementations, the data aggregation platform may receive the first customer data in near-real time relative to detecting an interaction between the customer and the merchant.

As further shown in FIG. 1E, and by reference number 140, the data aggregation platform may receive, from a server device, second customer data associated with the customer. In some implementations, the second customer data may include data associated with the customer, but unassociated with interactions between the customer and the merchant. For example, the second customer data may include financial data associated with the customer, demographic data associated with the customer, data captured by cameras in a store of the merchant with respect to particular products offered by the merchant, and/or the like. In some implementations, the data aggregation platform may receive the second customer data in near-real time relative to detecting an interaction between the customer and the merchant.

The data aggregation platform may pre-process the first customer data and the second customer to generate first structured customer data and second structured customer data in a manner similar to the manner described above in connection with FIG. 1B for the first historical customer data and the second historical customer data.

As shown in FIG. 1F, and by reference number 145, the data aggregation platform may process the first customer data and the second customer data, with the trained first model, to determine a sentiment of the customer. The sentiment of the customer may relate to a polarity of an opinion of the customer, an emotion of the customer, an intention of the customer, an aspect of a product and/or service to which an opinion of the customer applies, classifications of customer sentiment (e.g., positive, neutral, negative, and/or the like), an extent of customer sentiment (e.g., a numerical score indicating an extent of satisfaction), and/or the like. For example, the data aggregation platform may determine, based on the first customer data and the second customer data, that the sentiment of the customer is that the customer is unsatisfied. In another example, the first customer data and the second customer data may be received over a time period (e.g., in days, weeks, months, and/or the like), and the data aggregation platform may determine one or more sentiments of the customer of the time period.

In some implementations, prior to processing the first customer data and the second customer data with the trained first model, the data aggregation platform may process (e.g., with natural language processing technique, a data cleansing technique, and/or the like) the first customer data and/or the second customer data into a particular format, and may aggregate the first customer data and/or the second customer in the particular format to generate aggregated data. The data aggregation platform may process the aggregated data, with the trained first model, to determine the sentiment of the customer.

As shown in FIG. 1G, and by reference number 150, the data aggregation platform may process the data identifying the sentiment of the customer, with the trained second model, to determine customer insight data that indicates an insight of the customer. For example, the data aggregation platform may determine an insight of the customer (e.g., the customer is unsatisfied with customer service provided by the merchant) based on the customer sentiment indicating that the customer is unsatisfied, as described above. Alternatively, the data aggregation platform may determine that providing the customer a gift card as an insight of the customer that is unsatisfied with the customer service of the merchant. In another example, if the customer is determined to be angry with the merchant, the data aggregation platform may determine that providing the customer a refund as an insight of the customer that is angry with the merchant.

As shown in FIG. 1H, and by reference number 155, the data aggregation platform may identify other customers that are similar to the customer and based on the customer insight data. In some implementations, the data aggregation platform may identify other customers, from the customers, that are similar to the customer and based on the insight of the customer, and may determine another insight of the customer based on insights of the other customers. For example, the data aggregation platform may determine that the customer unsatisfied with the customer service provided by the merchant is similar to five other customers and that the five other customers became more satisfied when they were offered a rebate for a product. Thus, the data aggregation platform may offer the same rebate to the customer.

As shown in FIG. 1I, and by reference number 160, the data aggregation platform may perform one or more actions based on the customer insight data. In some implementations, the data aggregation platform may perform the one or more actions based on identifying other customers that are similar to the customer based on the customer insight data, as described above in connection with FIG. 1H.

For example, the one or more actions may include the data aggregation platform generating a report that includes the customer insight data. In this way, the data aggregation platform may automatically provide customer insight data that a merchant may analyze and interpret, which may conserve computing resources (e.g., processing resources, memory resources, and/or the like), communication resources, networking resources, and/or the like that would otherwise be wasted in attempting to analyze unstructured and incomplete information about customers, incorrectly inferring insights about customers based on the incomplete information, improperly serving the customers based on the incorrect insights, and/or the like.

In one example, the data aggregation platform may identify a first group of customers that purchased a particular item from the merchant and have called and complained about the particular item. The data aggregation platform may proactively identify a second group of customers who have purchased the particular item but who haven't called and complained about the particular item. The data aggregation platform may generate the report for the first group of customers, and may take steps to keep the second group of customers from calling and complaining. If the data aggregation platform resolved the previous calls by shipping another item to the first group of customers, the data aggregation platform may automatically ship the other item to the second group of customers, may notify customer service to offer the other item to the second group of customers if any of the customers in the second group call, and/or the like.

The one or more actions may include the data aggregation platform providing the customer insight data to other customer models (e.g., other customer sentiment models, customer insight models, and/or the like). In this way, the data aggregation platform may improve the other customer models so that other customer insights may be determined, which may conserve computing resources, communication resources, networking resources, and/or the like that would otherwise be wasted in attempting to analyze unstructured and incomplete information about customers, incorrectly inferring insights about customers based on the incomplete information, improperly serving the customers based on the incorrect insights, and/or the like.

The one or more actions may include the data aggregation platform storing the customer insight data in a data structure that includes other customer information. For example, the data aggregation platform may store the customer insight data in a data structure that enables an employee of a merchant, who is not a data analysis expert, to understand insights associated with the customer. In this way, the data aggregation platform may provide the customer insight data in an easily understandable format that prevents wasting computing resources, communication resources, networking resources, and/or the like associated with gathering and understanding customer insight data.

The one or more actions may include the data aggregation platform generating a graphical representation of a path of the customer through a hierarchy of the merchant. For example, the data aggregation platform may generate a chart that represents interactions with a customer (e.g., a customer service call, an email received from the customer, a chat session with the customer, and/or the like), time passage between the interactions (e.g., in minutes, hours, days, and/or the like), actions taken based on the interactions (e.g., offered a rebate, provided a gift card, and/or the like), and/or the like. In this way, the data aggregation platform may enable a merchant to more comprehensively and efficiently view a progression of customer interactions, more quickly identify customer issues associated with the customer interactions, and more quickly diagnose customer issues.

The one or more actions may include the data aggregation platform determining a plan of action for the merchant based on the customer insight data. For example, the data aggregation platform may utilize the customer insight data to determine actions to take with respect to the customer (e.g., call the customer back tomorrow, offer the customer a free product and/or service, offer the customer a rebate, and/or the like), to remove an item from store shelves (e.g., via a robot or by placing a work order for removal of the item with an employee), to remove the item from a merchant website, and/or the like. In this way, the data aggregation platform may provide an employee of the merchant with a plan of action for the customer without wasting computing resources, communication resources, networking resources, and/or the like associated gathering incomplete customer data, generating an incomplete plan of action based on the incomplete customer data, and unsuccessfully implementing the incomplete plan of action.

The one or more actions may include the data aggregation platform defining an alert for the merchant based on the customer insight data. For example, the data aggregation platform may receive, from a user device, a request to generate an alert when the customer performs an activity associated with the merchant (e.g., calls the merchant a quantity of times), may receive information indicating that the customer performed the activity associated with the merchant (e.g., called the merchant at least the quantity of times), and may provide, to the user device, the alert based on receiving the information indicating that the customer performed the activity associated with the merchant. In this way, the data aggregation platform may provide an immediate notification to the merchant if the customer performs an activity on which the merchant wishes to act (e.g., to address customer issues), thereby improving customer satisfaction and improving speed and efficiency associated with addressing issues of the customer.

The one or more actions may include the data aggregation platform retraining the models (e.g., the first model, the second model, and/or the like) based on the customer insight data. In this way, the data aggregation platform may improve the accuracy of the models in determining customer sentiment data, customer insight data, and/or the like, which may improve speed and efficiency of the models and conserve computing resources, communication resources, networking resources, and/or the like.

In some implementations, the data aggregation platform may provide other features that enable the merchant to better serve customers and conserve resources. For example, the data aggregation platform may provide a web portal that presents the aggregated data, the customer sentiment data, the customer insight data, and/or the like to employees of the merchant; allows the employees to view current alerts associated with the customers; allows the employees to define rules for generating alerts; and/or the like.

Additionally, or alternatively, the data aggregation platform may provide a search tool that may receive, from a user device, a search query for data associated with the customer, may select data identifying the insight of the customer based on the search query, and may provide the data identifying the insight of the customer to the user device. The search tool may enable an employee of the merchant to provide search queries that generate search results associated with the aggregated data, the customer sentiment data, the customer insight data, and/or the like, and to view the search results quickly and easily.

Additionally, or alternatively, the data aggregation platform may provide a work flow management tool that allows employees of the merchant to review data associated with customers (e.g., the first historical customer data, the second historical customer data, the first customer data, the second customer data, and/or the like) and determine actions to take with respect to the customers. The work flow management tool may also enable the employees to assign and manage tasks associated with the actions, to define rules associated with alerts (e.g., who is to be notified; a type of alert to be used, such as a visual alert, an email alert, a text message alert, and/or the like; when the alert is to be generated; and/or the like.

In this way, several different stages of the process for aggregating data and identifying insights from the aggregated data may be performed more quickly and efficiently, which may conserve computing resources (e.g., processing resources, memory resources, and/or the like), communication resources, networking resources, and/or the like. Furthermore, implementations described herein use a rigorous, computerized process to perform tasks or roles that were not previously performed or were previously performed using subjective human intuition or input. For example, currently there does not exist a technique that utilizes models to aggregate data and to identify insights from the aggregated data. Finally, the process for utilizing models to aggregate data and to identify insights from the aggregated data conserves computing resources, communication resources, networking resources, and/or the like that would otherwise be wasted by attempting to analyze unstructured and incomplete information about customers, incorrectly inferring insights about customers based on the incomplete information, improperly serving the customers based on the incorrect insights, and/or the like.

As indicated above, FIGS. 1A-1I are provided merely as examples. Other examples may differ from what is described with regard to FIGS. 1A-1I.

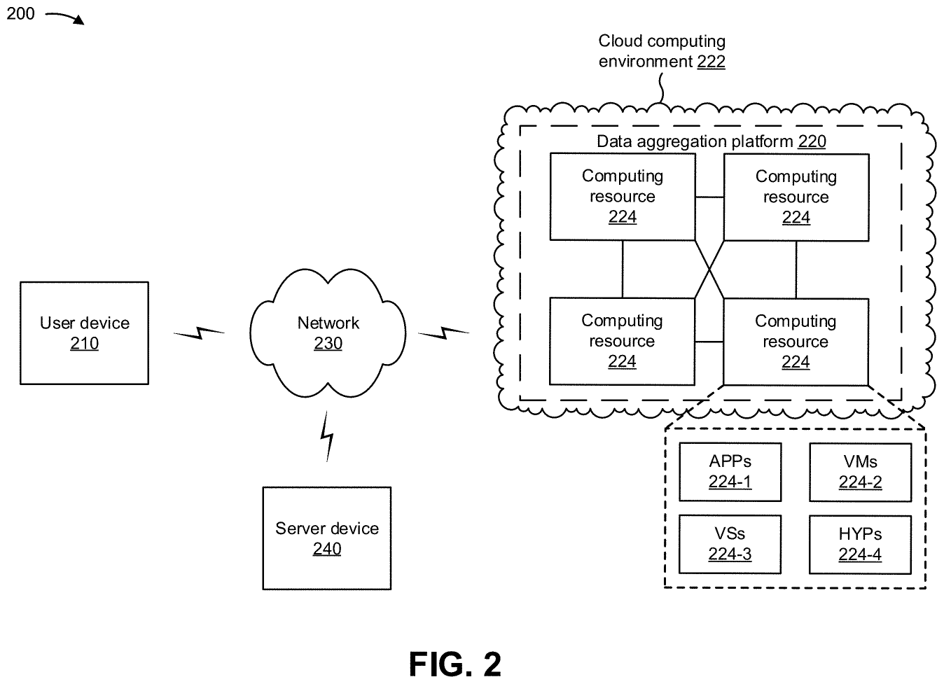

FIG. 2 is a diagram of an example environment 200 in which systems and/or methods described herein may be implemented. As shown in FIG. 2, environment 200 may include a user device 210, a data aggregation platform 220, a network 230, and a server device 240. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), a camera (e.g., a security camera, a closed-circuit television (CCTV) camera, a smart camera, a satellite camera, etc.), or a similar type of device. In some implementations, user device 210 may receive information from and/or transmit information to data aggregation platform 220 and/or server device 240.

Data aggregation platform 220 includes one or more devices that may utilize models to aggregate data and to identify insights from the aggregated data. In some implementations, data aggregation platform 220 may be modular such that certain software components may be swapped in or out depending on a particular need. As such, data aggregation platform 220 may be easily and/or quickly reconfigured for different uses. In some implementations, data aggregation platform 220 may receive information from and/or transmit information to one or more user devices 210 and/or server devices 240.

In some implementations, as shown, data aggregation platform 220 may be hosted in a cloud computing environment 222. Notably, while implementations described herein describe data aggregation platform 220 as being hosted in cloud computing environment 222, in some implementations, data aggregation platform 220 may be non-cloud-based (i.e., may be implemented outside of a cloud computing environment) or may be partially cloud-based.

Cloud computing environment 222 includes an environment that may host data aggregation platform 220. Cloud computing environment 222 may provide computation, software, data access, storage, etc. services that do not require end-user knowledge of a physical location and configuration of system(s) and/or device(s) that host data aggregation platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host data aggregation platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with data aggregation platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of user device 210 or an operator of data aggregation platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may provide administrators of the storage system with flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Server device 240 includes one or more devices capable of receiving, generating, storing, processing, and/or providing information, such as information described herein. For example, server device 240 may include a laptop computer, a tablet computer, a desktop computer, a group of server devices, or a similar type of device, associated with a government agency, a financial institution, a social service organization, and/or the like. In some implementations, server device 240 may receive information from and/or transmit information to user device 210 and/or data aggregation platform 220.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device and/or a single device shown in FIG. 2 may be implemented as multiple, distributed devices. Additionally, or alternatively, a set of devices (e.g., one or more devices) of environment 200 may perform one or more functions described as being performed by another set of devices of environment 200.

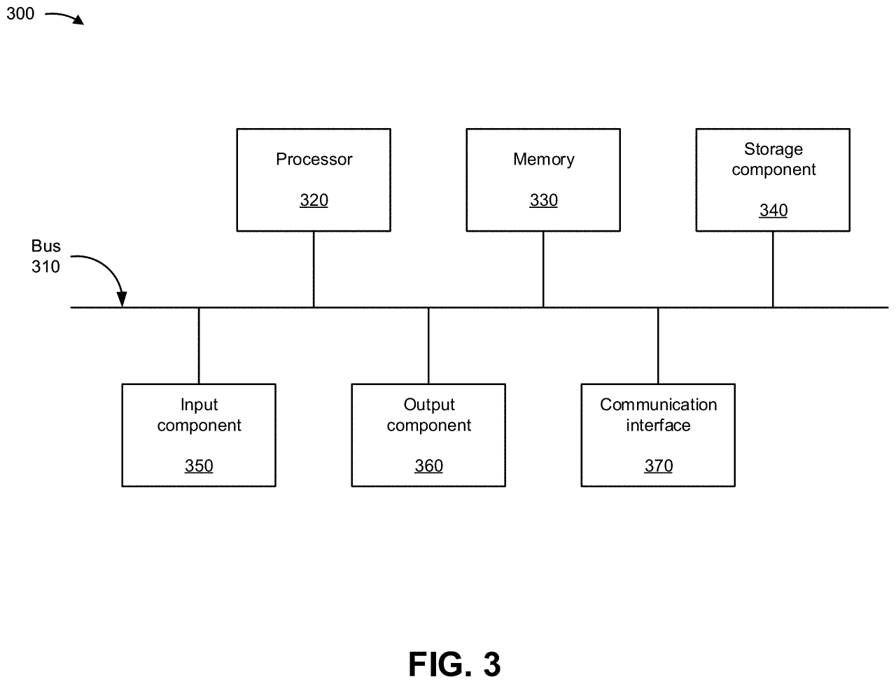

FIG. 3 is a diagram of example components of a device 300. Device 300 may correspond to user device 210, data aggregation platform 220, computing resource 224, and/or server device 240. In some implementations, user device 210, data aggregation platform 220, computing resource 224, and/or server device 240 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

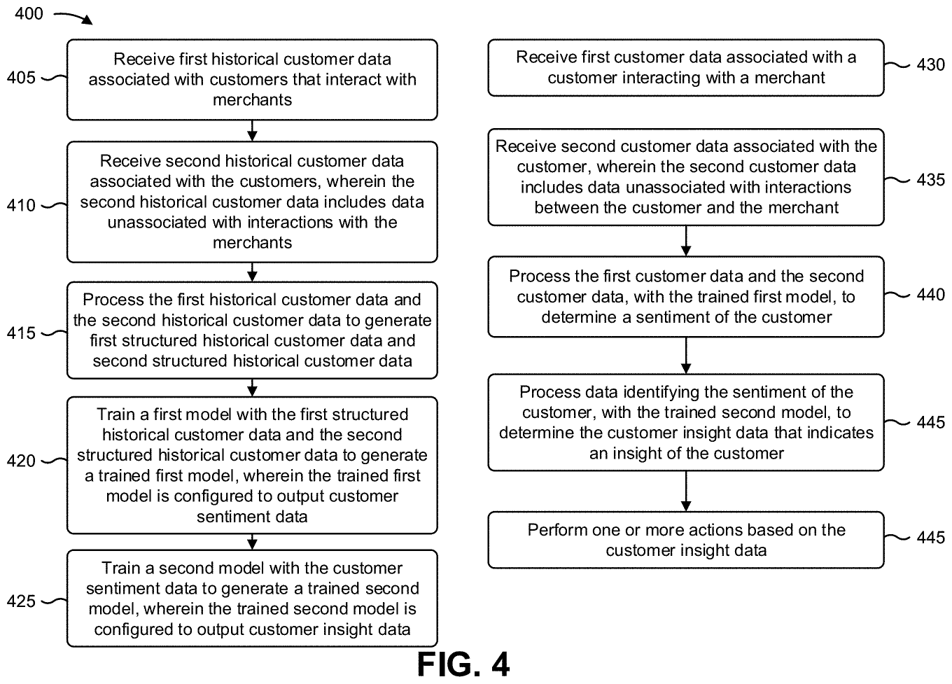

FIG. 4 is a flow chart of an example process 400 for utilizing models to aggregate data and to identify insights from the aggregated data. In some implementations, one or more process blocks of FIG. 4 may be performed by a device (e.g., data aggregation platform 220). In some implementations, one or more process blocks of FIG. 4 may be performed by another device or a group of devices separate from or including the device, such as a user device (e.g., user device 210) and/or a server device (e.g., server device 240).

As shown in FIG. 4, process 400 may include receiving first historical customer data associated with customers that interact with merchants (block 405). For example, the device (e.g., using computing resource 224, processor 320, communication interface 370, and/or the like) may receive first historical customer data associated with customers that interact with merchants, as described above.

As further shown in FIG. 4, process 400 may include receiving second historical customer data associated with the customers, wherein the second historical customer data includes data unassociated with interactions with the merchants (block 410). For example, the device (e.g., using computing resource 224, processor 320, communication interface 370, and/or the like) may receive second historical customer data associated with the customers, as described above. In some implementations, the second historical customer data includes data unassociated with interactions with the merchants.

As further shown in FIG. 4, process 400 may include processing the first historical customer data and the second historical customer data to generate first structured historical customer data and second structured historical customer data (block 415). For example, the device (e.g., using computing resource 224, processor 320, memory 330, and/or the like) may process the first historical customer data and the second historical customer data to generate first structured historical customer data and second structured historical customer data, as described above.

As further shown in FIG. 4, process 400 may include training a first model with the first structured historical customer data and the second structured historical customer data to generate a trained first model, wherein the trained first model is configured to output customer sentiment data (block 420). For example, the device (e.g., using computing resource 224, processor 320, storage component 340, and/or the like) may train a first model with the first structured historical customer data and the second structured historical customer data to generate a trained first model, as described above. In some implementations, the trained first model is configured to output customer sentiment data.

As further shown in FIG. 4, process 400 may include training a second model with the customer sentiment data to generate a trained second model, wherein the trained second model is configured to output customer insight data (block 425). For example, the device (e.g., using computing resource 224, processor 320, memory 330, and/or the like) may train a second model with the customer sentiment data to generate a trained second model, as described above. In some implementations, the trained second model is configured to output customer insight data.

As further shown in FIG. 4, process 400 may include receiving first customer data associated with a customer interacting with a merchant (block 430). For example, the device (e.g., using computing resource 224, processor 320, communication interface 370, and/or the like) may receive first customer data associated with a customer interacting with a merchant, as described above.

As further shown in FIG. 4, process 400 may include receiving second customer data associated with the customer, wherein the second customer data includes data unassociated with interactions between the customer and the merchant (block 435). For example, the device (e.g., using computing resource 224, processor 320, communication interface 370, and/or the like) may receive second customer data associated with the customer, as described above. In some implementations, the second customer data includes data unassociated with interactions between the customer and the merchant.

As further shown in FIG. 4, process 400 may include processing the first customer data and the second customer data, with the trained first model, to determine a sentiment of the customer (block 440). For example, the device (e.g., using computing resource 224, processor 320, storage component 340, and/or the like) may process the first customer data and the second customer data, with the trained first model, to determine a sentiment of the customer, as described above.

As further shown in FIG. 4, process 400 may include processing data identifying the sentiment of the customer, with the trained second model, to determine the customer insight data that indicates an insight of the customer (block 445). For example, the device (e.g., using computing resource 224, processor 320, memory 330, and/or the like) may process data identifying the sentiment of the customer, with the trained second model, to determine the customer insight data that indicates an insight of the customer, as described above.

As further shown in FIG. 4, process 400 may include performing one or more actions based on the customer insight data (block 450). For example, the device (e.g., using computing resource 224, processor 320, memory 330, storage component 340, communication interface 370, and/or the like) may perform one or more actions based on the customer insight data, as described above.

Process 400 may include additional implementations, such as any single implementation or any combination of implementations described below and/or in connection with one or more other processes described elsewhere herein.

In a first implementation, performing the one or more actions includes performing the one or more actions based on identifying the other customers.

In a second implementation, alone or in combination with the first implementation, performing the one or more actions includes generating a report that includes the customer insight data; providing the customer insight data to one or more other models associated with one or more of the customers; storing the customer insight data in a data structure that includes the first historical customer data and the second historical customer data; or generating a graphical representation of a path of the customer through a hierarchy of the merchant.

In a third implementation, alone or in combination with one or more of the first and second implementations, performing the one or more actions includes determining a plan of action for the merchant, with respect to the customer, based on the customer insight data; determining an alert for the merchant based on the customer insight data; or retraining the first model and/or the second model based on the customer insight data.

In a fourth implementation, alone or in combination with one or more of the first through third implementations, the first model includes a latent Dirichlet allocation (LDA) model or a sentiment analysis model.

In a fifth implementation, alone or in combination with one or more of the first through fourth implementations, the second model includes an impact assessment model, a customers as assets model, a propensity model, a cross-sell analysis model, or a critical lag model.

In a sixth implementation, alone or in combination with one or more of the first through fifth implementations, the first historical customer data includes data identifying notes about the customers that are generated by employees of the merchants, transcripts of customer service calls with the customers, transcripts of online customer chats with the customers, or emails exchanged with the customers.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

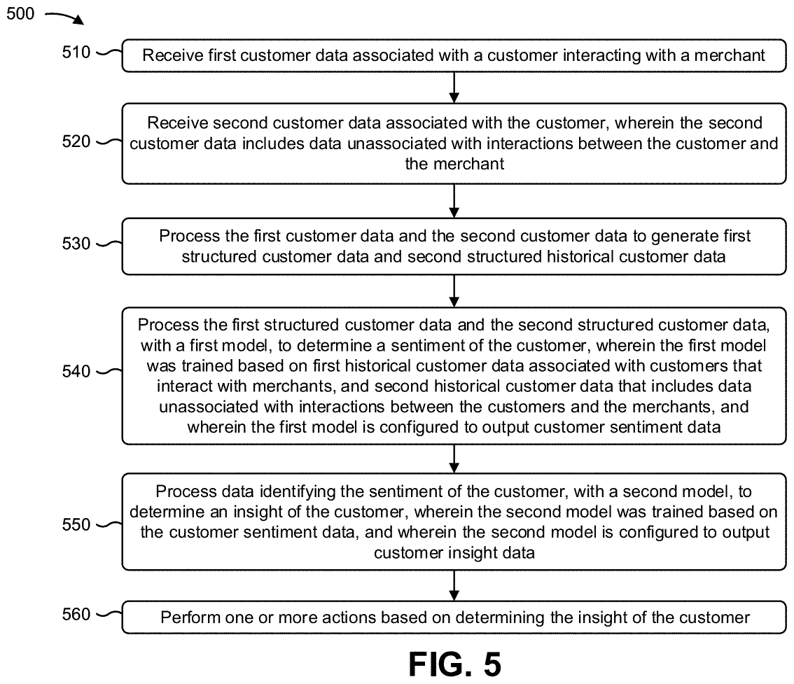

FIG. 5 is a flow chart of an example process 500 for utilizing models to aggregate data and to identify insights from the aggregated data. In some implementations, one or more process blocks of FIG. 5 may be performed by a device (e.g., data aggregation platform 220). In some implementations, one or more process blocks of FIG. 5 may be performed by another device or a group of devices separate from or including the device, such as a user device (e.g., user device 210) and/or a server device (e.g., server device 240).

As shown in FIG. 5, process 500 may include receiving first customer data associated with a customer interacting with a merchant (block 510). For example, the device (e.g., using computing resource 224, processor 320, communication interface 370, and/or the like) may receive first customer data associated with a customer interacting with a merchant, as described above.

As further shown in FIG. 5, process 500 may include receiving second customer data associated with the customer, wherein the second customer data includes data unassociated with interactions between the customer and the merchant (block 520). For example, the device (e.g., using computing resource 224, processor 320, communication interface 370, and/or the like) may receive second customer data associated with the customer, as described above. In some implementations, the second customer data includes data unassociated with interactions between the customer and the merchant.

As further shown in FIG. 5, process 500 may include processing the first customer data and the second customer data to generate first structured customer data and second structured historical customer data (block 530). For example, the device (e.g., using computing resource 224, processor 320, memory 330, and/or the like) may process the first customer data and the second customer data to generate first structured customer data and second structured historical customer data, as described above.

As further shown in FIG. 5, process 500 may include processing the first structured customer data and the second structured customer data, with a first model, to determine a sentiment of the customer, wherein the first model was trained based on first historical customer data associated with customers that interact with merchants, and second historical customer data that includes data unassociated with interactions between the customers and the merchants, and wherein the first model is configured to output customer sentiment data (block 540). For example, the device (e.g., using computing resource 224, processor 320, storage component 340, and/or the like) may process the first structured customer data and the second structured customer data, with a first model, to determine a sentiment of the customer, as described above. In some implementations, the first model was trained based on first historical customer data associated with customers that interact with merchants, and second historical customer data that includes data unassociated with interactions between the customers and the merchants. In some implementations, the first model is configured to output customer sentiment data.

As further shown in FIG. 5, process 500 may include processing data identifying the sentiment of the customer, with a second model, to determine an insight of the customer, wherein the second model was trained based on the customer sentiment data, and wherein the second model is configured to output customer insight data (block 550). For example, the device (e.g., using computing resource 224, processor 320, memory 330, and/or the like) may process data identifying the sentiment of the customer, with a second model, to determine an insight of the customer, as described above. In some implementations, the second model was trained based on the customer sentiment data. In some implementations, the second model is configured to output customer insight data.

As further shown in FIG. 5, process 500 may include performing one or more actions based on determining the insight of the customer (block 560). For example, the device (e.g., using computing resource 224, processor 320, memory 330, storage component 340, communication interface 370, and/or the like) may perform one or more actions based on determining the insight of the customer, as described above.

Process 500 may include additional implementations, such as any single implementation or any combination of implementations described below and/or in connection with one or more other processes described elsewhere herein.

In a first implementation, the second historical customer data includes financial data associated with the customers, demographic data associated with the customers, or purchase history data associated with the customers.

In a second implementation, alone or in combination with the first implementation, process 500 includes processing the first historical customer data and the second historical customer data to convert the first historical customer data and the second historical customer data from an unstructured format into a particular structured format for the first structured historical customer data and the second structured historical customer data; and aggregating the first structured historical customer data and the second structured historical customer data, in the particular structured format, to generate aggregated data.

In a third implementation, alone or in combination with one or more of the first and second implementations, the first model is trained with the aggregated data.

In a fourth implementation, alone or in combination with one or more of the first through third implementations, the first customer data and the second customer data are received in near-real time relative to detecting an interaction between the customer and the merchant.

In a fifth implementation, alone or in combination with one or more of the first through fourth implementations, process 500 includes receiving, from a user device, a search query for data associated with the customer; selecting data identifying the insight of the customer based on the search query; and providing the data identifying the insight of the customer to the user device.

In a sixth implementation, alone or in combination with one or more of the first through fifth implementations, process 500 includes receiving, from a user device, a request to generate an alert when the customer performs an activity associated with the merchant; receiving information indicating that the customer performed the activity associated with the merchant; and providing, to the user device, the alert based on receiving the information indicating that the customer performed the activity associated with the merchant.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

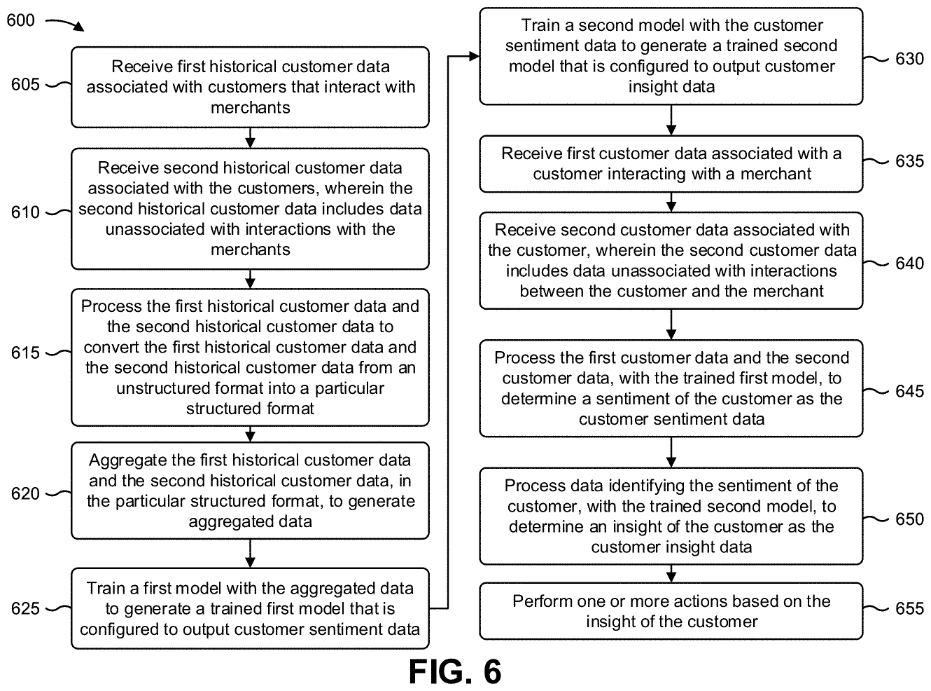

FIG. 6 is a flow chart of an example process 600 for utilizing models to aggregate data and to identify insights from the aggregated data. In some implementations, one or more process blocks of FIG. 6 may be performed by a device (e.g., data aggregation platform 220). In some implementations, one or more process blocks of FIG. 6 may be performed by another device or a group of devices separate from or including the device, such as a user device (e.g., user device 210) and/or a server device (e.g., server device 240).

As shown in FIG. 6, process 600 may include receiving first historical customer data associated with customers that interact with merchants (block 605). For example, the device (e.g., using computing resource 224, processor 320, communication interface 370, and/or the like) may receive first historical customer data associated with customers that interact with merchants, as described above.

As further shown in FIG. 6, process 600 may include receiving second historical customer data associated with the customers, wherein the second historical customer data includes data unassociated with interactions with the merchants (block 610). For example, the device (e.g., using computing resource 224, processor 320, communication interface 370, and/or the like) may receive second historical customer data associated with the customers, as described above. In some implementations, the second historical customer data includes data unassociated with interactions with the merchants.

As further shown in FIG. 6, process 600 may include processing the first historical customer data and the second historical customer data to convert the first historical customer data and the second historical customer data from an unstructured format into a particular structured format (block 615). For example, the device (e.g., using computing resource 224, processor 320, memory 330, and/or the like) may process the first historical customer data and the second historical customer data to convert the first historical customer data and the second historical customer data from an unstructured format into a particular structured format, as described above.

As further shown in FIG. 6, process 600 may include aggregating the first historical customer data and the second historical customer data, in the particular structured format, to generate aggregated data (block 620). For example, the device (e.g., using computing resource 224, processor 320, storage component 340, and/or the like) may aggregate the first historical customer data and the second historical customer data, in the particular structured format, to generate aggregated data, as described above.

As further shown in FIG. 6, process 600 may include training a first model with the aggregated data to generate a trained first model that is configured to output customer sentiment data (block 625). For example, the device (e.g., using computing resource 224, processor 320, memory 330, and/or the like) may train a first model with the aggregated data to generate a trained first model that is configured to output customer sentiment data, as described above.

As further shown in FIG. 6, process 600 may include training a second model with the customer sentiment data to generate a trained second model that is configured to output customer insight data (block 630). For example, the device (e.g., using computing resource 224, processor 320, storage component 340, and/or the like) may train a second model with the customer sentiment data to generate a trained second model that is configured to output customer insight data, as described above.

As further shown in FIG. 6, process 600 may include receiving first customer data associated with a customer interacting with a merchant (block 635). For example, the device (e.g., using computing resource 224, processor 320, communication interface 370, and/or the like) may receive first customer data associated with a customer interacting with a merchant, as described above.

As further shown in FIG. 6, process 600 may include receiving second customer data associated with the customer, wherein the second customer data includes data unassociated with interactions between the customer and the merchant (block 640). For example, the device (e.g., using computing resource 224, processor 320, communication interface 370, and/or the like) may receive second customer data associated with the customer, as described above. In some implementations, the second customer data includes data unassociated with interactions between the customer and the merchant.

As further shown in FIG. 6, process 600 may include processing the first customer data and the second customer data, with the trained first model, to determine a sentiment of the customer as the customer sentiment data (block 645). For example, the device (e.g., using computing resource 224, processor 320, memory 330, and/or the like) may process the first customer data and the second customer data, with the trained first model, to determine a sentiment of the customer as the customer sentiment data, as described above.

As further shown in FIG. 6, process 600 may include processing data identifying the sentiment of the customer, with the trained second model, to determine an insight of the customer as the customer insight data (block 650). For example, the device (e.g., using computing resource 224, processor 320, storage component 340, and/or the like) may process data identifying the sentiment of the customer, with the trained second model, to determine an insight of the customer as the customer insight data, as described above.

As further shown in FIG. 6, process 600 may include performing one or more actions based on the insight of the customer (block 655). For example, the device (e.g., using computing resource 224, processor 320, memory 330, storage component 340, communication interface 370, and/or the like) may perform one or more actions based on the insight of the customer, as described above.

Process 600 may include additional implementations, such as any single implementation or any combination of implementations described below and/or in connection with one or more other processes described elsewhere herein.

In a first implementation, process 600 may include identifying other customers, from the customers and that are similar to the customer, based on the insight of the customer; and determining another insight of the customer based on insights associated with the other customers.

In a second implementation, alone or in combination with the first implementation, performing the one or more actions includes generating a report that includes the customer insight data; providing the customer insight data to one or more other models associated with one or more of the customers; storing the customer insight data in a data structure that includes the first historical customer data and the second historical customer data; or generating a graphical representation of a path of the customer through a hierarchy of the merchant.

In a third implementation, alone or in combination with one or more of the first and second implementations, performing the one or more actions includes determining a plan of action for the merchant, with respect to the customer, based on the customer insight data; determining an alert for the merchant based on the customer insight data; or retraining the first model or the second model based on the customer insight data.

In a fourth implementation, alone or in combination with one or more of the first through third implementations, the first customer data and the second customer data are received in near-real time relative to detecting an interaction between the customer and the merchant.

In a fifth implementation, alone or in combination with one or more of the first through fourth implementations, process 600 includes receiving, from a user device, a search query for data associated with the customer; selecting data identifying the insight of the customer based on the search query; and providing the data identifying the insight of the customer to the user device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, first historical customer data associated with customers that interact with merchants;
receiving, by the device, second historical customer data associated with the customers,
wherein the second historical customer data includes data unassociated with interactions with the merchants;
processing, by the device, the first historical customer data and the second historical customer data to generate first structured historical customer data and second structured historical customer data;
training, by the device, a first model with the first structured historical customer data and the second structured historical customer data to generate a trained first model,
wherein the trained first model is configured to output customer sentiment data;
training, by the device, a second model with the customer sentiment data to generate a trained second model,
wherein the trained second model is configured to output customer insight data;
receiving, by the device, first customer data associated with a customer interacting with a merchant;
receiving, by the device, second customer data associated with the customer,
wherein the second customer data includes data unassociated with interactions between the customer and the merchant;
processing, by the device, the first customer data and the second customer data, with the trained first model, to determine a sentiment of the customer;
processing, by the device, data identifying the sentiment of the customer, with the trained second model, to determine the customer insight data that indicates an insight of the customer; and
performing, by the device, one or more actions based on the customer insight data.

2. The method of claim 1, further comprising:
identifying other customers, from the customers and that are similar to the customer, based on the customer insight data, and
wherein performing the one or more actions comprises:
performing the one or more actions based on identifying the other customers.

3. The method of claim 1, wherein performing the one or more actions comprises one or more of:
generating a report that includes the customer insight data,
providing the customer insight data to one or more other models associated with one or more of the customers,
storing the customer insight data in a data structure that includes the first historical customer data and the second historical customer data, or
generating a graphical representation of a path of the customer through a hierarchy of the merchant.

4. The method of claim 1, wherein performing the one or more actions comprises one or more of:
determining a plan of action for the merchant, with respect to the customer, based on the customer insight data,
determining an alert for the merchant based on the customer insight data, or
retraining the first model and/or the second model based on the customer insight data.

5. The method of claim 1, wherein the first model includes one or more of:
a latent Dirichlet allocation (LDA) model, or
a sentiment analysis model.

6. The method of claim 1, wherein the second model includes one or more of:
an impact assessment model,
a customers as assets model,
a propensity model,
a cross-sell analysis model, or
a critical lag model.

7. The method of claim 1, wherein the first historical customer data includes data identifying one or more of:
notes about the customers that are generated by employees of the merchants,
transcripts of customer service calls with the customers,
transcripts of online customer chats with the customers, or
emails exchanged with the customers.

8. A device, comprising:
one or more memories; and
one or more processors, communicatively coupled to the one or more memories, configured to:
receive first customer data associated with a customer interacting with a merchant;
receive second customer data associated with the customer,
wherein the second customer data includes data unassociated with interactions between the customer and the merchant;
process the first customer data and the second customer data to generate first structured customer data and second structured historical customer data;
process the first structured customer data and the second structured customer data, with a first model, to determine a sentiment of the customer,
wherein the first model was trained based on:
first historical customer data associated with customers that interact with merchants, and
second historical customer data that includes data unassociated with interactions between the customers and the merchants, and
wherein the first model is configured to output customer sentiment data;
process data identifying the sentiment of the customer, with a second model, to determine an insight of the customer,
wherein the second model was trained based on the customer sentiment data, and
wherein the second model is configured to output customer insight data; and
perform one or more actions based on determining the insight of the customer.

9. The device of claim 8, wherein the second historical customer data includes one or more of:
financial data associated with the customers,
demographic data associated with the customers, or
purchase history data associated with the customers.

10. The device of claim 8, wherein, when processing the first historical customer data and the second historical customer data to generate the first structured historical customer data and the second structured historical customer data, the one or more processors are configured to:
process the first historical customer data and the second historical customer data to convert the first historical customer data and the second historical customer data from an unstructured format into a particular structured format for the first structured historical customer data and the second structured historical customer data; and
aggregate the first structured historical customer data and the second structured historical customer data, in the particular structured format, to generate aggregated data.

11. The device of claim 10, wherein the first model is trained with the aggregated data.

12. The device of claim 8, wherein the first customer data and the second customer data are received in near-real time relative to detecting an interaction between the customer and the merchant.

13. The device of claim 8, wherein the one or more processors are further configured to:
receive, from a user device, a search query for data associated with the customer;
select data identifying the insight of the customer based on the search query; and
provide the data identifying the insight of the customer to the user device.

14. The device of claim 8, wherein the one or more processors are further configured to:
receive, from a user device, a request to generate an alert when the customer performs an activity associated with the merchant;
receive information indicating that the customer performed the activity associated with the merchant; and
provide, to the user device, the alert based on receiving the information indicating that the customer performed the activity associated with the merchant.

15. A non-transitory computer-readable medium storing instructions, the instructions comprising:
one or more instructions that, when executed by one or more processors, cause the one or more processors to:
receive first historical customer data associated with customers that interact with merchants;
receive second historical customer data associated with the customers,
wherein the second historical customer data includes data unassociated with interactions with the merchants;
process the first historical customer data and the second historical customer data to convert the first historical customer data and the second historical customer data from an unstructured format into a particular structured format;
aggregate the first historical customer data and the second historical customer data, in the particular structured format, to generate aggregated data;
train a first model with the aggregated data to generate a trained first model that is configured to output customer sentiment data;
train a second model with the customer sentiment data to generate a trained second model that is configured to output customer insight data;
receive first customer data associated with a customer interacting with a merchant;
receive second customer data associated with the customer,
wherein the second customer data includes data unassociated with interactions between the customer and the merchant;
process the first customer data and the second customer data, with the trained first model, to determine a sentiment of the customer as the customer sentiment data;
process data identifying the sentiment of the customer, with the trained second model, to determine an insight of the customer as the customer insight data; and
perform one or more actions based on the insight of the customer.

16. The non-transitory computer-readable medium of claim 15, wherein the instructions further comprise:
one or more instructions that, when executed by the one or more processors, cause the one or more processors to:
identify other customers, from the customers and that are similar to the customer, based on the insight of the customer, and
determine another insight of the customer based on insights associated with the other customers.

17. The non-transitory computer-readable medium of claim 15, wherein the one or more instructions, that cause the one or more processors to perform the one or more actions, cause the one or more processors to one or more of:
generate a report that includes the customer insight data,
provide the customer insight data to one or more other models associated with one or more of the customers,
store the customer insight data in a data structure that includes the first historical customer data and the second historical customer data, or
generate a graphical representation of a path of the customer through a hierarchy of the merchant.

18. The non-transitory computer-readable medium of claim 15, wherein the one or more instructions, that cause the one or more processors to perform the one or more actions, cause the one or more processors to one or more of:
determine a plan of action for the merchant, with respect to the customer, based on the customer insight data,
determine an alert for the merchant based on the customer insight data, or
retrain the first model or the second model based on the customer insight data.

19. The non-transitory computer-readable medium of claim 15, wherein the first customer data and the second customer data are received in near-real time relative to detecting an interaction between the customer and the merchant.

20. The non-transitory computer-readable medium of claim 15, wherein the instructions further comprise:
one or more instructions that, when executed by the one or more processors, cause the one or more processors to:
receive, from a user device, a search query for data associated with the customer;
select data identifying the insight of the customer based on the search query; and
provide the data identifying the insight of the customer to the user device.
